(19) United States
(12) Patent Application Publication
(10) Pub. No.: US 2016/0008842 A1
(43) Pub. Date: Jan. 14, 2016

(54) Device for Dispensing a Sealant or other Material

(71) Applicant: AIRBUS OPERATIONS LIMITED, Bristol (GB)

(72) Inventor: Richard DOBBIN, Bristol (GB)

(21) Appl. No.: 14/795,929

(22) Filed: Jul. 10, 2015

(30) Foreign Application Priority Data
Jul. 11, 2014 (GB) 1412380.6

(51) Int. Cl. B05C 17/015; B05C 17/005

(52) U.S. Cl. CPC B05C 17/015; B05C 17/00503; B05C 17/00593

(57) ABSTRACT

A device for dispensing a sealant or other material. The device has a housing containing a chamber with a dispensing orifice at a first end and an actuation opening at a second end opposite the first end. The chamber contains a mixing paddle which can be rotated and translated back and forth inside the chamber; a piston; and a membrane with an open end in fluid communication with the actuation opening. The membrane is arranged such that it can be inflated by injecting fluid into its open end via the actuation opening, inflation of the membrane causing it to press against the piston and push the piston towards the mixing paddle and the dispensing orifice which in turn forces the material past the mixing paddle and out of the dispensing orifice.

### FIELD OF THE INVENTION

The present invention relates to a device for dispensing a sealant or other fluid material.

### BACKGROUND OF THE INVENTION

A known device for mixing and dispensing sealant or other material is the Semkit® package provided by PPG Industries. The package can be used to store, mix and apply multiple component adhesives, sealants, encapsulants and other material. The Semkit® package assures accurate proportioning of the materials since the pre-measured components are stored in different compartments within the cartridge.

### SUMMARY OF THE INVENTION

A first aspect of the invention provides a device for dispensing a sealant or other material. The device comprises a housing containing a chamber with a dispensing orifice at a first end (for dispensing the material) and an actuation opening at a second end opposite the first end. The chamber contains a piston; and a membrane with an open end in fluid communication with the actuation opening. The membrane is arranged such that it can be inflated by injecting fluid (typically a gas such as compressed air) into its open end via the actuation opening, inflation of the membrane causing it to press against the piston and push the piston towards the dispensing orifice which in turn forces the material out of the dispensing orifice.

The device can be used to dispense any fluid material, such as an adhesive, sealant or encapsulant—for example an epoxy, polysulfide, polyurethane or silicone material.

The material may be a single part material, or a two-part or multi-part material (for instance a base part and a hardener part of a two-part adhesive or sealant).

The chamber may contain the material, or it may be provided empty for filling by an end user.

The device may be for dispensing the sealant or other material, without also being for mixing the sealant or other material. Alternatively the device may be for mixing and dispensing the sealant or other material.

The chamber may comprise a mixing paddle which can be rotated in the chamber and translated back and forth in the chamber to mix the material. Inflation of the membrane in such a chamber may cause it to press against the piston and push the piston towards the mixing paddle and the dispensing orifice which in turn forces the material past the mixing paddle and out of the dispensing orifice.

The device may further comprise a dasher rod which engages the mixing paddle or can be inserted through the dispensing orifice into engagement with the mixing paddle so that the mixing paddle can be rotated within the chamber by the dasher rod and translated back and forth in the chamber by the dasher rod. The dasher rod may be provided to an end user in-situ (i.e. inserted into the chamber in engagement with the mixing paddle) or it may be provided as a separate part which is inserted by the end user.

The dasher rod is typically removably attached to the mixing paddle (for instance by a threaded connection) so it can be removed after the mixing paddle has mixed the material.

In the case where the material is a two-part material, then preferably the dasher rod comprises a dasher rod compartment for containing fluid dasher rod material (for example hardener) and the device further comprises a ramrod which can be inserted into the dasher rod compartment to force the dasher rod material out of the dasher rod compartment and into the chamber.

The dasher rod compartment may contain the dasher rod material.

Typically the device is provided as a pre-filled cartridge with the chamber containing a first part of a two-part material; and the dasher rod compartment containing a second part of the two-part material.

Optionally the open end of the membrane is clamped against the housing, forming a fluid-tight seal. Such a clamping arrangement is desirable since it enables the membrane to be easily retro-fitted.

Optionally the device further comprises a part with an actuation orifice, wherein the open end of the membrane is in fluid communication with the actuation orifice such that the membrane can be inflated by injecting fluid into its open end via the actuation orifice, and wherein the part clamps the membrane against the housing, forming the fluid-tight seal.

Typically the part is removably fitted to the housing, for instance by a screw fitting or a bayonet fitting.

Optionally the device further comprises a tightening mechanism which can be operated to increase a clamping force which clamps the membrane against the housing.

Optionally the device further comprises a pneumatic gun with a gas inlet in fluid communication with the actuation orifice and/or the actuation opening.

### BRIEF DESCRIPTION OF THE DRAWINGS

Embodiments of the invention will now be described with reference to the accompanying drawings, in which:

FIG. 1 is a longitudinal sectional view of a device;

FIG. 2 shows the device with a ramrod inserted;

FIG. 3 shows the piston at the beginning of its travel;

FIG. 4 shows the piston at the end of its travel;

FIG. 5 shows the device of FIG. 1 fitted with a membrane;

FIG. 6 shows the membrane in an inflated state;

FIG. 7 shows a longitudinal sectional view of a device according to an alternative embodiment;

FIG. 8 shows the mixing paddle of the device of FIG. 7;

FIG. 9 shows a device according to a further embodiment with the membrane, piston, mixing paddle and nozzle extension not installed;

FIG. 10 shows the device of FIG. 9 with the membrane, piston, mixing paddle and nozzle extension installed but not yet fitted to a pneumatic gun; and

FIG. 11 is an enlarged view showing the interface with the pneumatic gun.

### DETAILED DESCRIPTION OF EMBODIMENT(S)

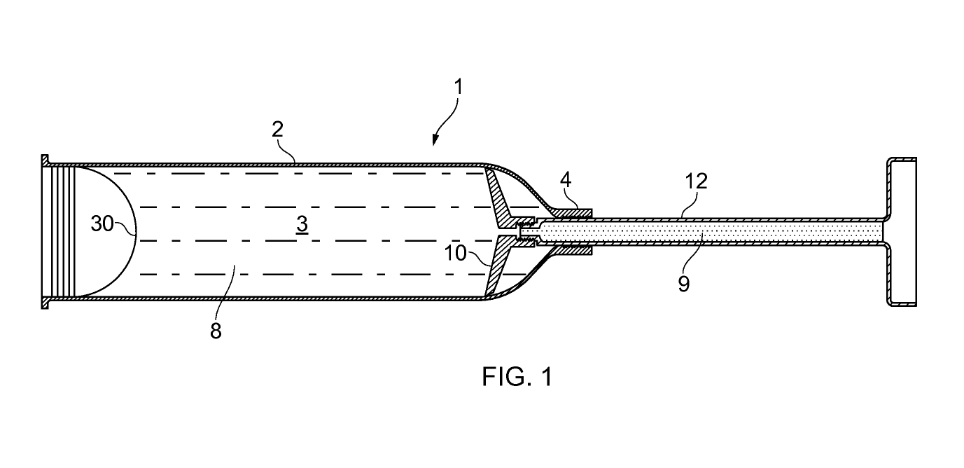

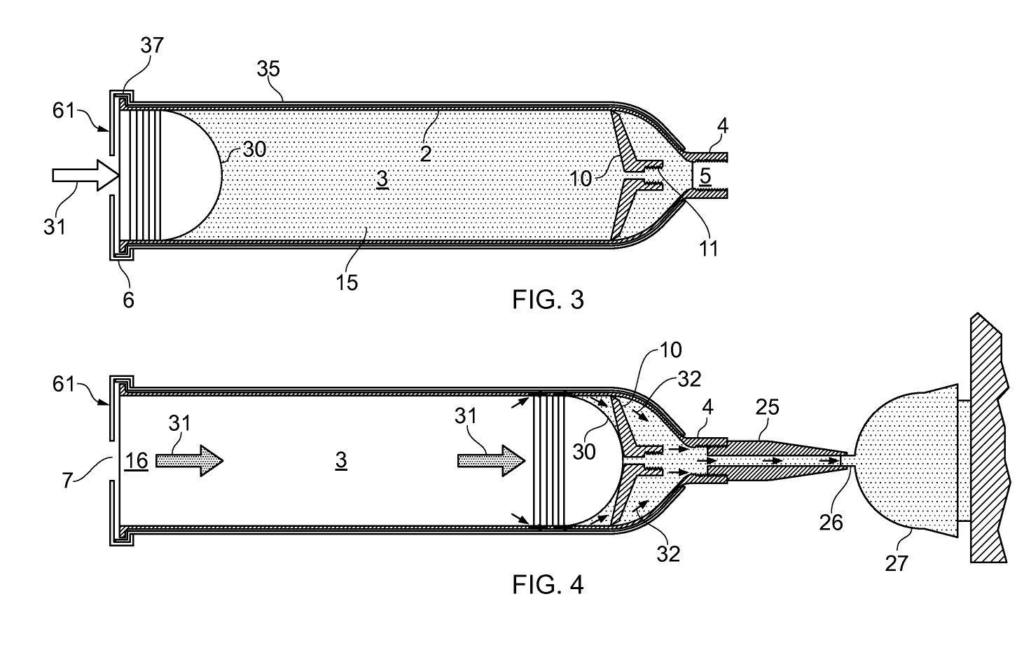

A device 1 for mixing and dispensing a two-part sealant or other fluid material is shown in FIGS. 1-4. For example the device may be a Semkit® package provided by PPG Industries. The device comprises a housing 2 containing a chamber 3. The housing has an internally threaded cylindrical nozzle 4 at one end which provides a dispensing orifice 5 shown in FIG. 3. The opposite end of the housing 3 has an actuation opening 16 (FIG. 4) which is closed by a piston 30. The piston 30 is formed by a thin-walled polymer such as polyethylene.

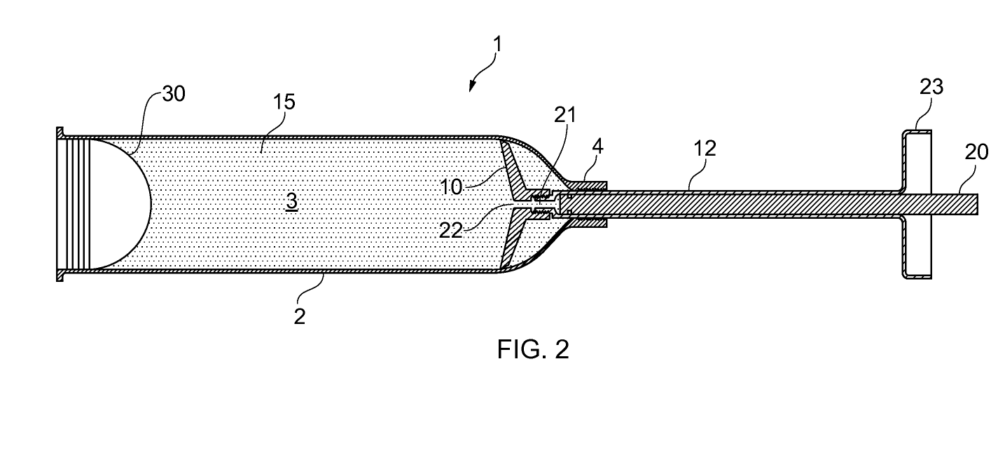

A mixing paddle 10 is provided inside the chamber 3. The paddle has an internally threaded bore 11 (shown most clearly in FIG. 3) and a number of blades, two of which are shown in the sectional view of FIGS. 1 and 2. Gaps (not shown) between the blades enable sealant to flow past the paddle towards the dispensing orifice 5. The paddle 10 is free to be rotated within the housing and also translated back and forth between the two ends of the chamber

The device 1 is provided to an end user as a pre-filled cartridge as shown in FIG. 1 containing a base component 8 of a two-part sealant in the chamber 3, and a hardener component 9 of the two-part sealant inside a dasher rod compartment in the dasher rod 12. The dasher rod 12 has an externally threaded end which is inserted through the dispensing orifice 5 and screwed into the bore 11 of the paddle 10. The hardener component 9 is then forced into the chamber by inserting a ramrod 20 shown in FIG. 2 into the dasher rod compartment. As the ramrod 20 is pushed in, it forces the hardener component 9 through an orifice 21 in the dasher rod, through an orifice 22 in the paddle, and into the chamber 3 where it mixes with the base component 8 to provide a mixed sealant 15 shown in FIG. 3.

After the hardener component has been injected into the chamber, the ramrod 20 is removed and the two components of the sealant 15 are thoroughly mixed together by the paddle 10. This is achieved by gripping a hand grip 23 at one end of the dasher rod 12, rotating the dasher rod 12 clockwise so that the paddle 10 rotates within the housing, and simultaneously pushing and pulling the dasher rod 12 back and forth so that the paddle 10 moves back and forth between the two ends of the chamber. This mixing process can be performed by hand or by a special mixing machine. The piston 30 prevents the sealant from being forced out of the left-hand side of the chamber during this process.

After the sealant 15 has been thoroughly mixed, the dasher rod 12 is removed by rotating it anti-clockwise to unscrew it from the mixing paddle, and withdrawing it through the dispensing orifice 5.

The sealant 15 is then dispensed as shown in FIGS. 3 and 4. The housing 2 is inserted into a casing 35 and the end of the chamber is partially closed by a part 6 of a pneumatic gun (not shown) having a substantially flat outer sealing surface 61, an ‘L’-shaped groove on an inner surface (not shown) and an actuation orifice 7. Note that the actuation opening 16 at the end of the chamber is only “partially” closed by the part 6 because the part 6 has an actuation orifice 7. A pneumatic gun (not shown) is fitted to the device by part 6 and operated to force compressed air 31 into the chamber via the actuation orifice 7. This pushes the piston 30 into the chamber 3 which in turn forces the sealant past the mixing paddle and out of the dispensing orifice 5. A nozzle extension 25 is threaded into the nozzle 4 and fitted to an inlet 26 of a nut cap 27. An example of a suitable nut cap 27 is given in WO2013/178985.

The piston 30 has a domed end face which engages with the paddle 10 as shown in FIG. 4 when the piston has reached the end of its travel. It has been observed that at this point air 32 can leak around the edges of the piston 30 and out of the dispensing orifice as shown in FIG. 4. This problem has not previously been identified, and it is speculated that the leakage may be caused by a slight distortion of the piston 30 caused by a mismatch between the domed profile of the piston 30 and the more flat profile of the paddle 10 resulting from so-called point loading, or a line contact between the piston and paddle leaving the surface between these lines of contact unsupported and free to distort. This leaking air causes voids in the sealant which can compromise the bond quality and leak tightness of the nut cap 27.

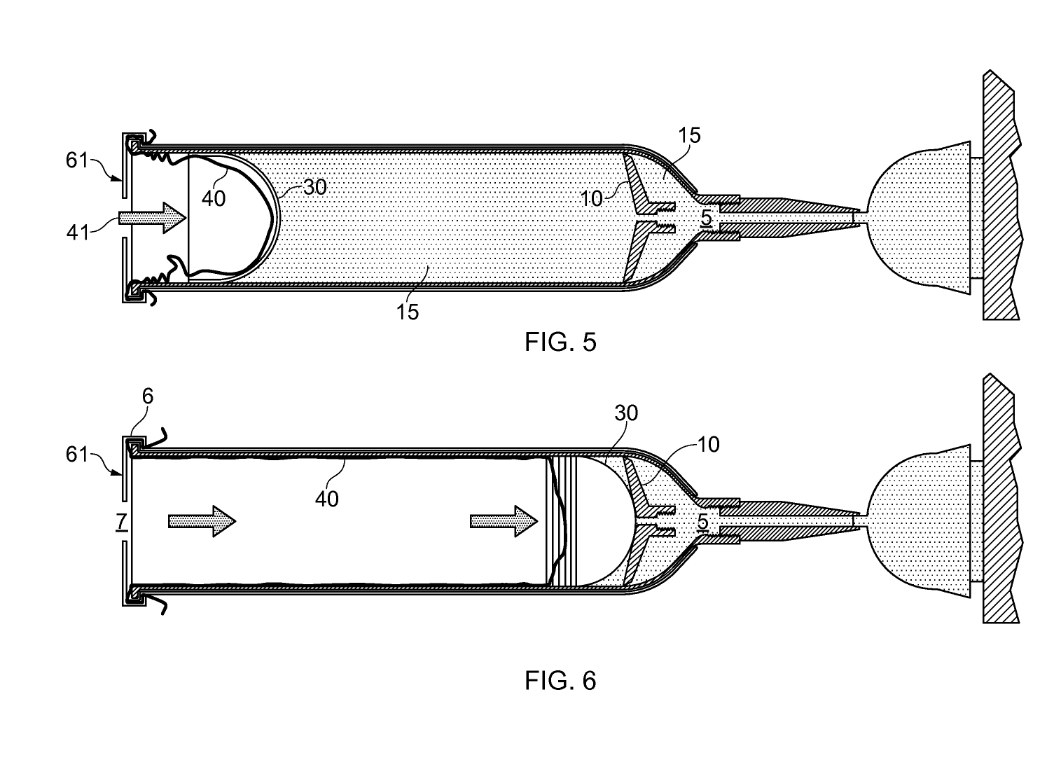

A solution to this problem is provided by installing a flexible membrane 40 inside the housing as shown in FIGS. 5 and 6.

The membrane 40 is inserted into the housing 2, such that an open end of the membrane 40 is in fluid communication with the actuation orifice 7. The housing 2 is inserted into the casing 35 as described above. The open end of the membrane 40 is folded over a pair of lugs 37 on the outer surface of the casing 35. The lugs 37 of the casing 35 fit into the internal groove of part 6 by a bayonet-type fitting, which clamps the open end of the membrane 40 against the housing 2, forming a fluid-tight seal.

The membrane 40 is thus arranged such that it can be inflated by injecting air 41 into its open end via the actuation orifice 7. Inflation of the membrane 40 causes it to press against the piston 30 and push the piston towards the dispensing orifice 5 which in turn forces the sealant 15 out of the dispensing orifice. FIGS. 5 and 6 shows the membrane in two states of inflation.

The membrane 40 is made of an elastomer such as latex rubber that is capable of significant expansion without puncturing. The membrane 40 contains the compressed air and thus prevents the leak path shown in FIG. 4.

This solution has the advantage that the membrane 40 can be retro-fitted to a conventional device without requiring any modification of the device.

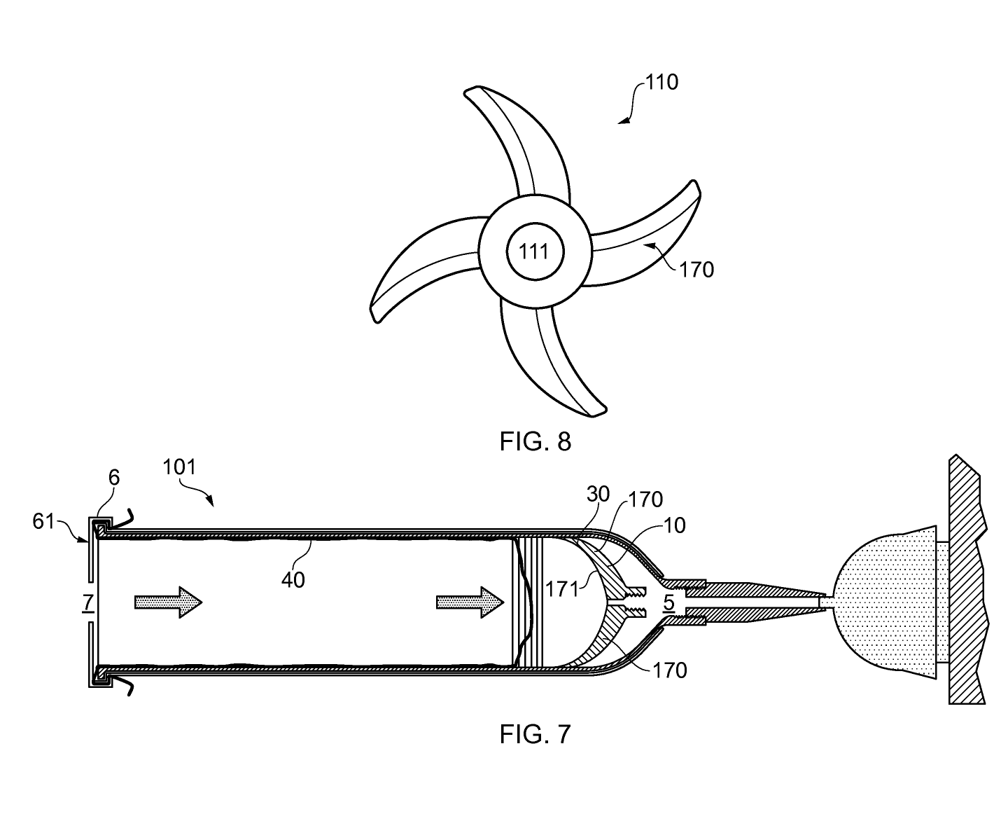

A device 101 according to an alternative embodiment of the invention is shown in FIG. 7. Like reference numerals are used to depict features present in the first embodiment and will not be described further.

The device 101 includes a mixing paddle 110 (more clearly shown in FIG. 8) having an internally threaded bore 111 and four blades 170, two of which are shown in the sectional view of FIG. 7. The blades 170 have an inner surface 171 that is domed.

The domed end face of the piston 30 engages with the paddle 110 as shown in FIG. 7 when the piston 30 has reached the end of its travel. Despite the domed end face of the piston 30 matching the domed inner surface 171 of the blades 170, it has been observed that at this point air can still leak around the edges of the piston 30 and out of the dispensing orifice (in a similar way to that shown in FIG. 4). The installation of a flexible membrane 40 inside the housing 2, as described above for the first embodiment, goes at least some way towards solving this problem.

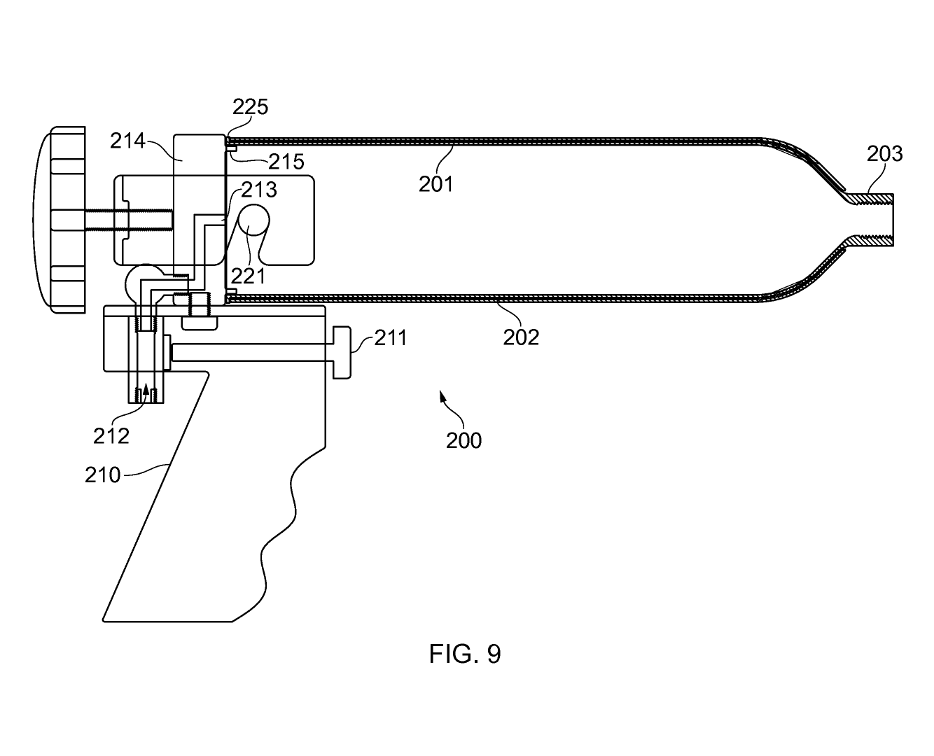

A device 200 according to a further embodiment of the invention is shown in FIGS. 9 to 11. The device comprises a housing 201 with a threaded nozzle 203 at one end, similar to the housing 2 in the first embodiment. A casing 202 (similar to the casing 35 in the first embodiment) is fitted over the housing 201. The casing 202 has a pair of lugs extending outwardly on opposite sides of the casing. Only one of the lugs 221 is shown in FIGS. 9-11.

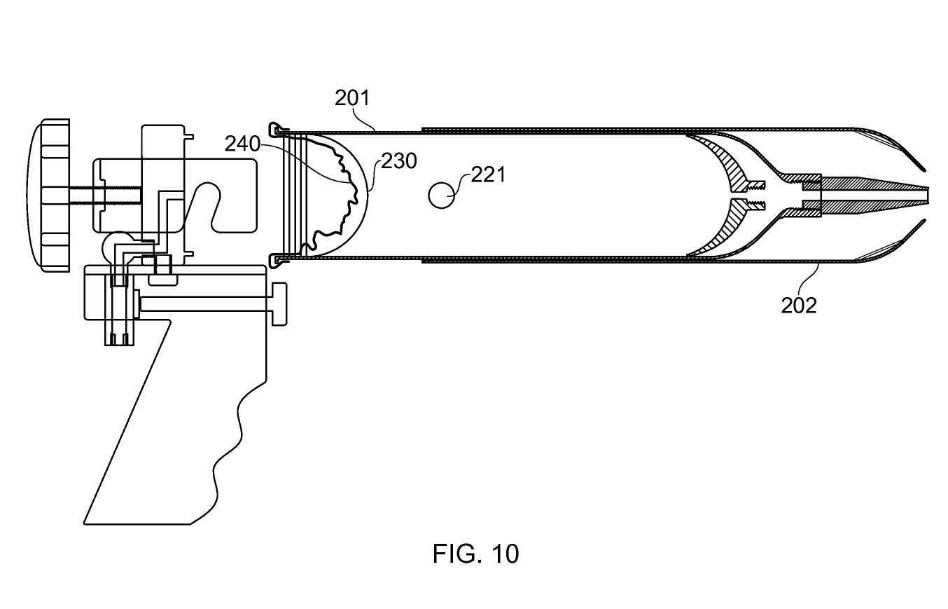

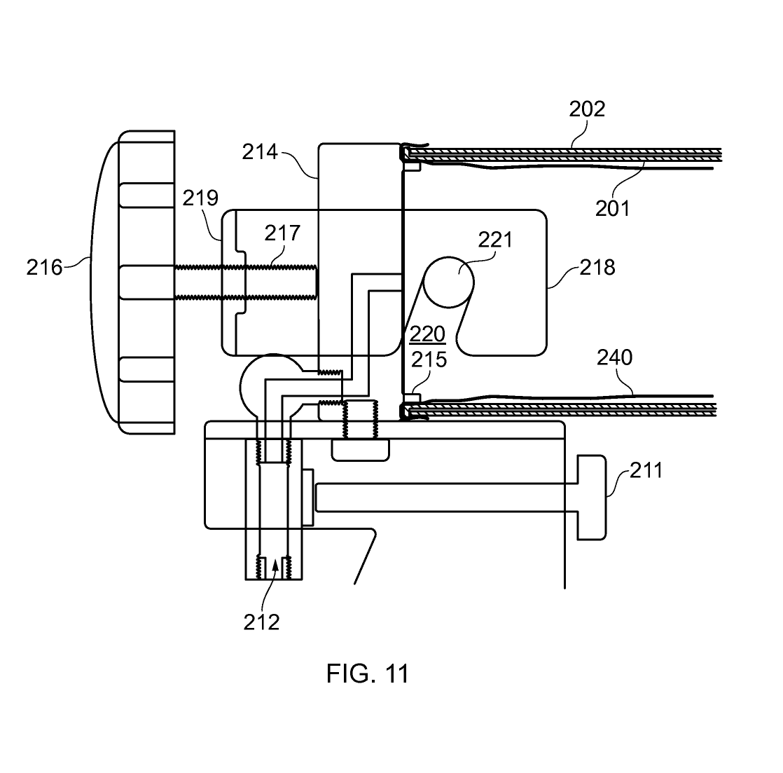

The device is assembled by first inserting the housing 201 into the casing 202 until the casing 202 abuts a circular flange 225. Next a membrane 240 (like the membrane 40 in the first embodiment) is fitted into the housing 201 as shown in FIG. 10 with the rim of the membrane stretched over the circular flange 225. Note that the housing 201 also contains a piston 230 (similar to piston 30) which is shown in FIG. 10 but omitted from FIGS. 9 and 11.

Next the assembled parts are fitted to a block 214 of a pneumatic gun as shown in detail in FIG. 11. The gun has a U-shaped bayonet fitting with a pair of bracket arms (forming the arms of the U) extending from a base 219 on opposite sides of the casing 202. Only one of the bracket arms 218 is shown in the Figures.

The block 214 has a circular flange 215 which is removably fitted inside the housing 201 as shown in FIGS. 9 and 11. Then the casing 202 is rotated until each lug 221 is received in a slot 220 of a respective bracket arm. A threaded thumb screw 217 passes through the base 219 of the bayonet bracket and abuts the rear face of the block 214. After the lugs 221 are in place in the slots 220, the thumb screw 217 is rotated by disk 216 which pulls the bayonet bracket to the left (in the viewing direction of FIGS. 9-11) relative to the block 214, so the block 214 clamps the open end of the membrane 240 against the flange 225 of the housing 201, forming a fluid-tight seal. Thus the thumb screw 217 and bayonet bracket together provide a tightening mechanism which can be manually operated to increase a clamping force which clamps the membrane 240 against the flange 225 of the housing.

The gun has an air fitting with an air inlet 212 for receiving air, and a handle 210 with a trigger 211. The block 214 has an actuation orifice in fluid communication with the air inlet 213. When the trigger 211 is pushed then air is injected into the inlet 212 and exits the actuation orifice 213 in the block 214, inflating the membrane.

As with the previous embodiments, the membrane 240 is thus arranged such that it can be inflated by injecting air into its open end via the actuation orifice 213. Inflation of the membrane 240 causes it to press against the piston 230 and push the piston towards the dispensing orifice in the threaded nozzle 203 which in turn forces sealant out of the dispensing orifice. FIGS. 10 and 11 show the membrane 240 in two states of inflation. In FIG. 11 the membrane is in its fully inflated state in which the walls of the membrane are stretched and in tension.

Although the invention has been described above with reference to one or more preferred embodiments, it will be appreciated that various changes or modifications may be made without departing from the scope of the invention as defined in the appended claims.

For example, a mixing paddle may not be provided within the chamber, for example when the sealant is pre-mixed.

1. A device for dispensing a sealant or other material, the device comprising: a housing containing a chamber with a dispensing orifice at a first end and an actuation opening at a second end opposite the first end, wherein the chamber contains: a piston; and a membrane with an open end in fluid communication with the actuation opening, wherein the membrane is arranged such that it can be inflated by injecting fluid into its open end via the actuation opening, inflation of the membrane causing it to press against the piston and push the piston towards the dispensing orifice which in turn forces the material out of the dispensing orifice.

2. The device of claim 1 wherein the device is for mixing and dispensing the sealant or other material.

3. The device of claim 2 wherein the chamber further comprises a mixing paddle which can be rotated in the chamber and translated back and forth in the chamber, and inflation of the membrane causes it to press against the piston and push the piston towards the mixing paddle and the dispensing orifice which in turn forces the material past the mixing paddle and out of the dispensing orifice.

4. The device of claim 3 further comprising a dasher rod which engages the mixing paddle or can be inserted through the dispensing orifice into engagement with the mixing paddle so that the mixing paddle can be rotated in the chamber by the dasher rod and translated back and forth in the chamber by the dasher rod.

5. The device of claim 4 wherein the dasher rod comprises a dasher rod compartment for containing dasher rod material, and the device further comprises a ramrod which can be inserted into the dasher rod compartment to force the dasher rod material out of the dasher rod compartment and into the chamber.

6. The device of claim 5 wherein the chamber contains a first part of a two-part material; and the dasher rod compartment contains a second part of the two-part material.

7. The device of claim 1 wherein the membrane is made of an elastomer.

8. The device of claim 1 wherein the open end of the membrane is clamped against the housing, forming a fluid-tight seal.

9. The device of claim 8 further comprising a part with an actuation orifice, wherein the open end of the membrane is in fluid communication with the actuation orifice such that the membrane can be inflated by injecting fluid into its open end via the actuation orifice, and wherein the part clamps the membrane against the housing, forming the fluid-tight seal.

10. The device of claim 9 wherein the part is removably fitted to the housing.

11. The device of claim 10 wherein the part is removably fitted to the housing by a bayonet fitting.

12. The device of claim 9, further comprising a tightening mechanism which can be operated to increase a clamping force which clamps the membrane against the housing.

13. The device of claim 9, further comprising a pneumatic gun with a gas inlet in fluid communication with the actuation orifice.

14. The device of claim 1, wherein the membrane is arranged such that it has a fully inflated state in which the membrane is stretched and in tension.
